(19) United States
(12) Patent Application Publication
(10) Pub. No.: US 2017/0363379 A1
(43) Pub. Date: Dec. 21, 2017

(54) CLAMSHELL GUNLOCK WITH BUFFER INSERT

(71) Applicant: Santa Cruz Gunlocks LLC, Webster, NH (US)

(72) Inventor: Tibor Kalman Zalavari, Budapest (HU)

(73) Assignee: Santa Cruz Gunlocks LLC, Webster, NH (US)

(21) Appl. No.: 15/622,999

(22) Filed: Jun. 14, 2017

Related U.S. Application Data
(60) Provisional application No. 62/350,608, filed on Jun. 15, 2016.

(51) Int. Cl. F41A 17/02; F41A 23/18; E05B 65/00; F41C 7/02

(52) U.S. Cl. CPC F41A 17/02; F41A 23/18; E05B 65/00; F41C 7/02

(57) ABSTRACT

An apparatus for adapting a clamshell-type of gunlock for a shotgun to lock a rifle. The clamshell gunlock can be easily modified using the apparatus without the need for basic changes to the gunlock. The apparatus has a single molded rubber part attached to the gunlock to hold the buffer tube of a rifle; providing a snug fitting constraint to hold the buffer tube of the rifle such that the rifle will not vibrate or move causing rattling sounds or damage to the rifle.

This application claims benefit of U.S. Provisional Application Ser. No. 62/350,608 filed Jun. 15, 2016, pursuant to 35 USC §119(e).

### FIELD OF THE INVENTION

This invention relates to gunlocks, in particular, a clamshell type of gunlock for a shotgun such that the gunlock can be adapted to lock a rifle via the buffer tube of the rifle.

### BACKGROUND OF THE INVENTION

The pump shotgun, a staple for law enforcement, was provided a locking mechanism in police vehicles as long ago as the early 1930's. This gunlock was originally designed by Smith & Wesson of 2100 Roosevelt Avenue, Springfield, Mass. The design proved to be so successful that it remained unchanged for many years. During 1988, this design was improved by Santa Cruz Gunlocks, LLC of Webster, New Hampshire by providing a manual override with a key so that the lock could be opened in the event of a power failure. (See FIG. 1, Prior Art).

Since police cruisers now have patrol rifles as a part of their weapon accessories, it was recognized that it would be advantageous to be able to convert the shotgun clamshell gunlock into a lock for rifles as well. This was easily done by the addition of insert 18 (see FIG. 3). This part of the gunlock is an aluminum-casting insert that is held in place by a hex head bolt that is screwed to base 15, (see FIG. 3) which has a threaded hole to receive the bolt.

However, despite the improvement, it was found that the rifle would rattle when being held by the modified lock. Further, the rattling caused cosmetic damage to the weapon resulting in scratches and dings to the metal. Most importantly, it was annoying to the police officer who was spending many hours driving in a vehicle and was forced to listen to his/her weapon rattling due to the weapon being held loosely within the lock.

At this time, there is no design that permits easily modifying standard clamshell gunlocks to lock a patrol rifle via the buffer tube firmly within the lock without rattling or vibration yet still be able to inexpensively and simply change the gunlock from locking a shotgun to a patrol rifle.

### SUMMARY OF THE INVENTION

It is an aspect of the invention to provide a clamshell type of gunlock for a pump shotgun, which can be easily modified to fit a rifle by insertion of a rubber-molded insert.

Another aspect of the invention is to provide a clamshell type of gunlock for a pump shotgun, which can be easily modified to fit a rifle by insertion of a rubber-molded insert that holds the buffer tube of the AR-15 without any vibration.

Still another aspect of the invention is to provide a clamshell type of gunlock for a pump shotgun, which can be easily modified to fit a rifle by insertion of a rubber-molded insert, which prevents the rifle from rattling when holding a rifle.

Still another aspect of the invention is to provide a clamshell type of gunlock for a pump shotgun, which can be easily modified to fit a rifle by insertion of a rubber-molded insert that prevents any cosmetic damage to the rifle while it is being held within the gunlock.

Finally, it is aspect of the invention to provide a clamshell type of gunlock for a pump shotgun which can be easily modified to fit a rifle by insertion of a rubber-molded insert that can be inexpensively manufactured and adapted to provide a clamshell type of gunlocks without any modifications or changes to the original structure.

### BRIEF DESCRIPTION OF THE DRAWINGS

FIG. 1 is an isometric view of a typical clamshell type of gunlock for a pump action shotgun such as made by Santa Cruz Gunlocks, Model SC-1.

FIG. 2A is a left isometric view of a typical clamshell type of gunlock with buffer tube insert in place shown in a closed position.

FIG. 2B is a left isometric view of the typical clamshell type of gunlock with buffer tube insert in place shown in an open position.

FIG. 3 is a left exploded isometric view of the typical clamshell type of gunlock showing the buffer tube insert in position to be attached to the gunlock.

FIG. 3A is a front view of the buffer tube insert.

FIG. 3B is top right isometric view of buffer tube insert.

FIG. 3C is bottom left isometric view of the buffer tube insert.

FIG. 4 is a top exploded isometric view of the buffer tube insert in position to be attached to the gunlock.

FIG. 4A is a top exploded isometric view of the buffer tube insert in position to be attached to the gunlock.

FIG. 5 is a bottom view of the buffer tube insert.

FIG. 5A is a front-end exploded view of the buffer tube in position to be attached to the gunlock.

FIG. 5B is a rear end view of the buffer tube in place on the gunlock.

FIG. 6 is an isometric view of the invention being used to lock a typical police rifle with the gunlock in an open position.

FIG. 7 is an isometric view of the gunlock shown in FIG. 6 in a locked position around the buffer tube of a typical police rifle.

### DETAILED DESCRIPTION OF THE INVENTION

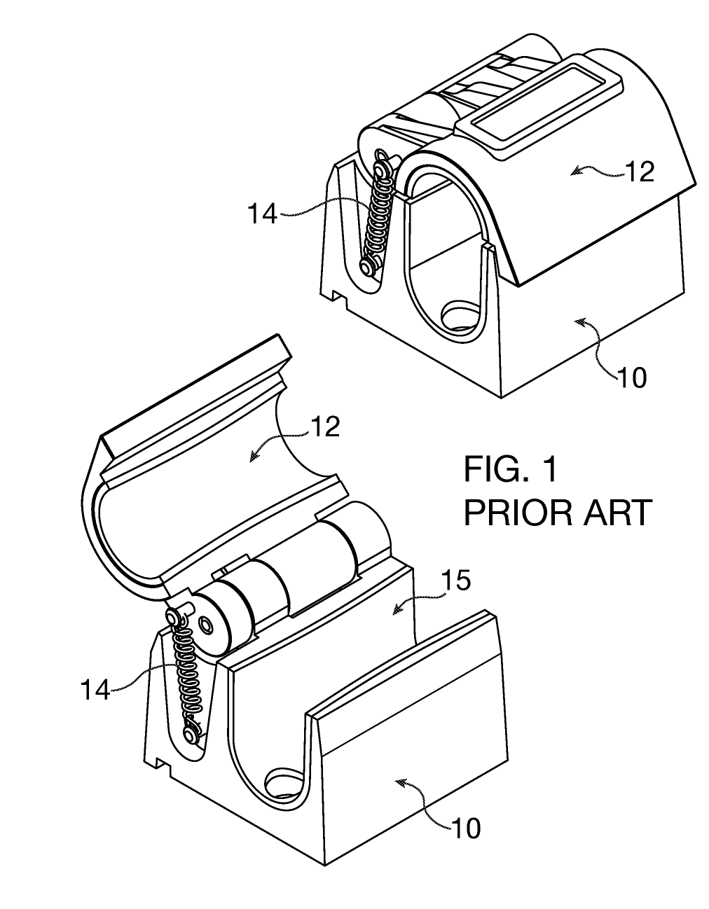

As shown in FIG. 1, prior art clamshell gunlock 10 is depicted in an isometric view. The apparatus is quite simple. Base 15 can be mounted on a structure such as a police vehicle such that a shotgun (not shown) can be firmly mounted wherein it cannot be removed by an unauthorized person. The shotgun is placed between arm 12 and base 15. Then arm 12 is hinged down on base 15 and locked, thus holding the shotgun firmly in place. Spring 14 keeps arm 12 fully open when the lock is in an unlocked position.

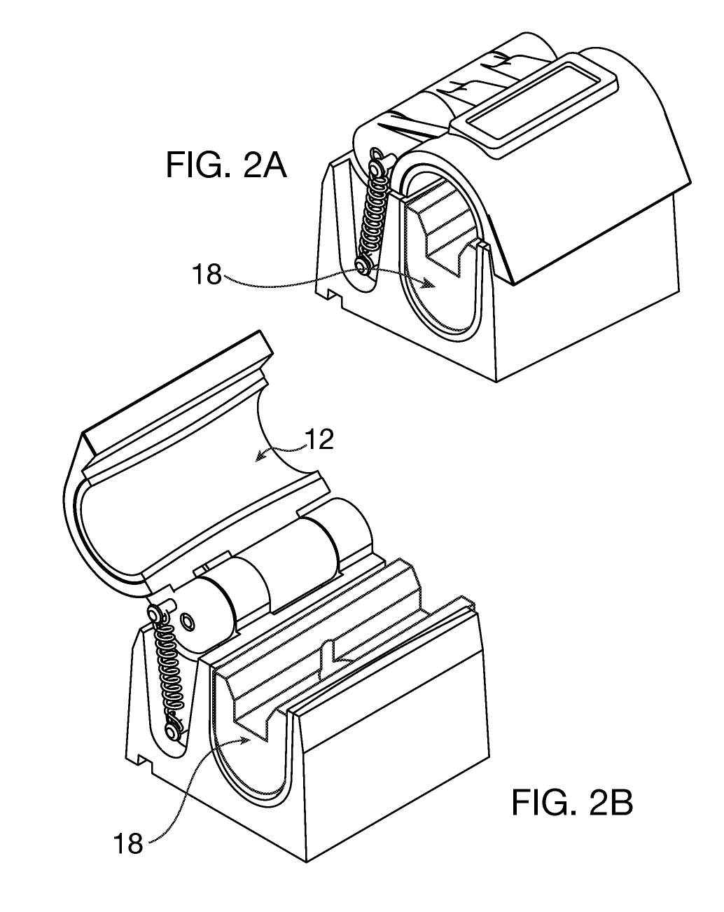

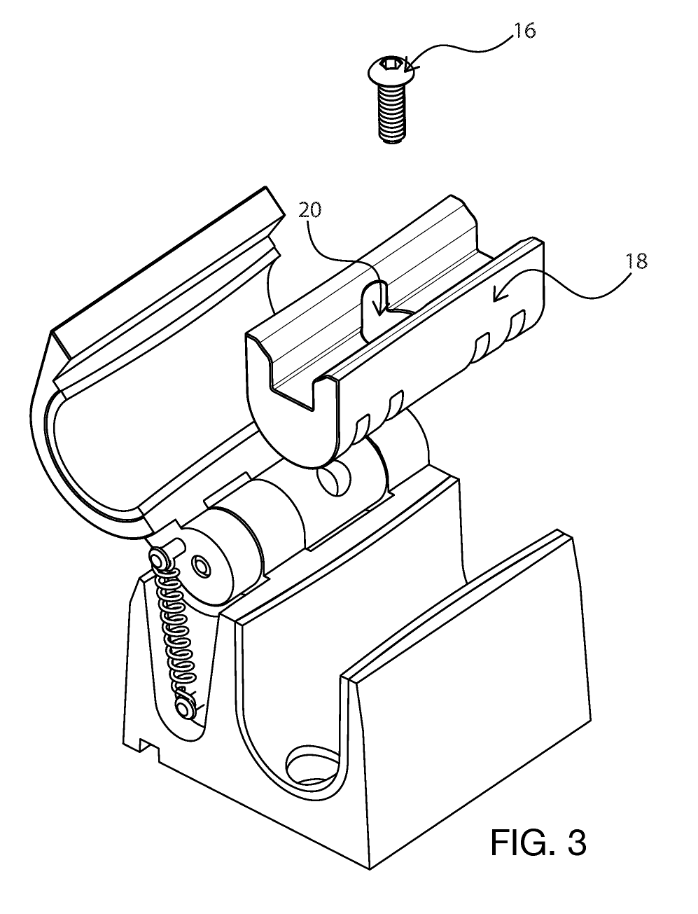

Now referring to FIGS. 2A and 2B, buffer tube insert 18 modification is shown in accordance with the invention. A molded rubber insert 18 is firmly attached to base 15 to narrow the opening between arm 12 and base 15. This modification permits locking a patrol rifle to the officer's vehicle. In particular, the modified lock does snugly constrain the rifle sufficiently to prevent vibration and movement such that the rifle will not rattle while being held by the buffer tube. Any rattle would be obviously extremely annoying to the vehicle occupants and will cause the rifle to suffer cosmetic damage.

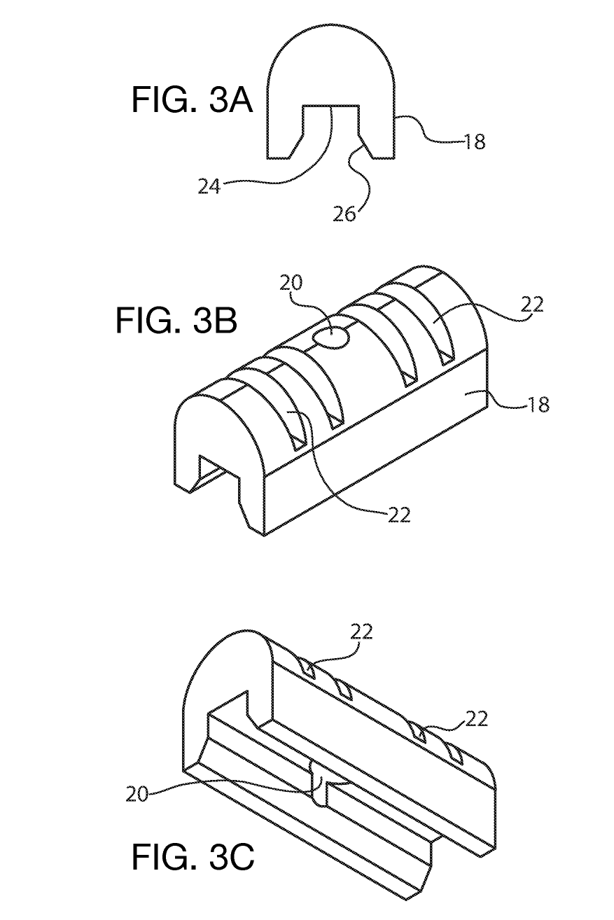

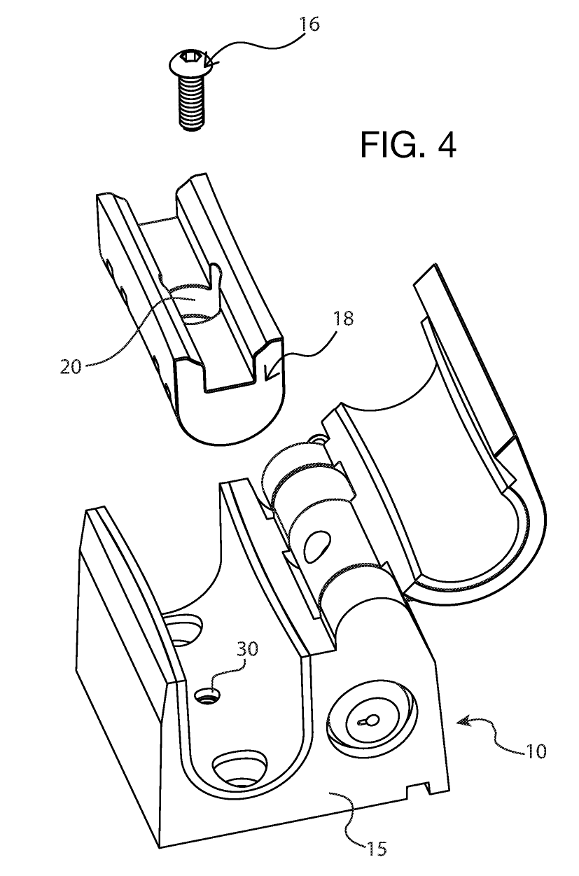

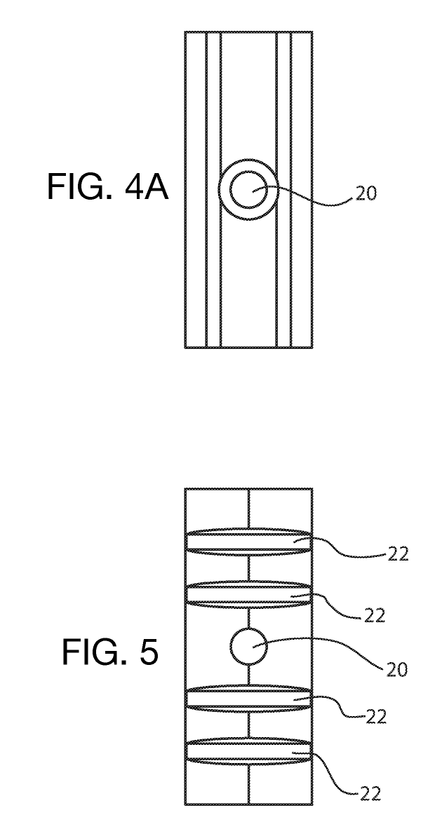

The essence of the invention is to provide an additional part, a rubber-molded insert 18 as shown in detail in FIGS. 3, 3A, 3B, and 3C. Insert 18 is attached to lock 10 by bolt 16 into opening 20 in buffer tube insert 18. Opening 20 is in insert 18 since it serves to provide access to threaded hex headed bolt 16 into threaded opening 30 in base 15 (see FIG. 4). A plurality of slots 22 (in this case, 4) are provided in insert 18, which serve to reduce the amount of material needed to mold insert 18. Channel 24 is molded into insert 18 so as to correspond to the diameter and cross-sectional shape of the buffer tube on the patrol rifle, typically an AR-15. Chamfer 26 is molded into insert 18 to help guide the buffer tube portion of the rifle into channel 24. Insert 18 is preferably about 3 inches long and about 1¼ inches wide. Channel 24 has a width corresponding to the diameter of the buffer tube on an AR-15 patrol rifle.

As shown in FIGS. 4, 4A, insert 18 is held within gunlock 10 via bolt 16 through opening 20 into threaded opening 30 in base 15 of gunlock 10.

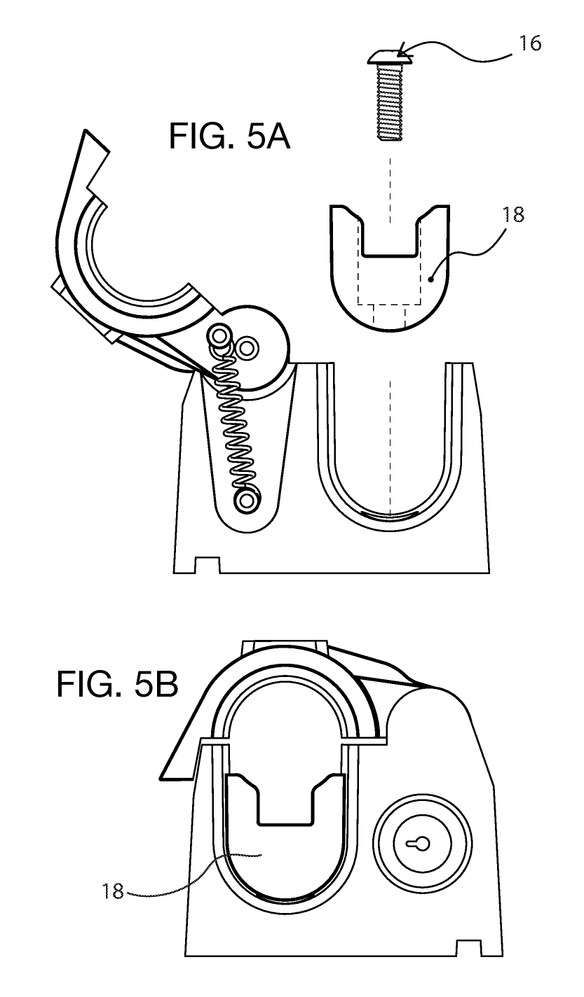

FIG. 5 shows the bottom view of buffer tube insert 18 outlining the spacing of finger slots 22 relative to opening 20 which serves to provide access to threaded opening 30 in base 15. FIG. 5A shows buffer tube insert in position to be held by bolt 16 to gunlock 10. FIG. 5B shows gunlock 10 in a closed position with buffer tube 18 in place.

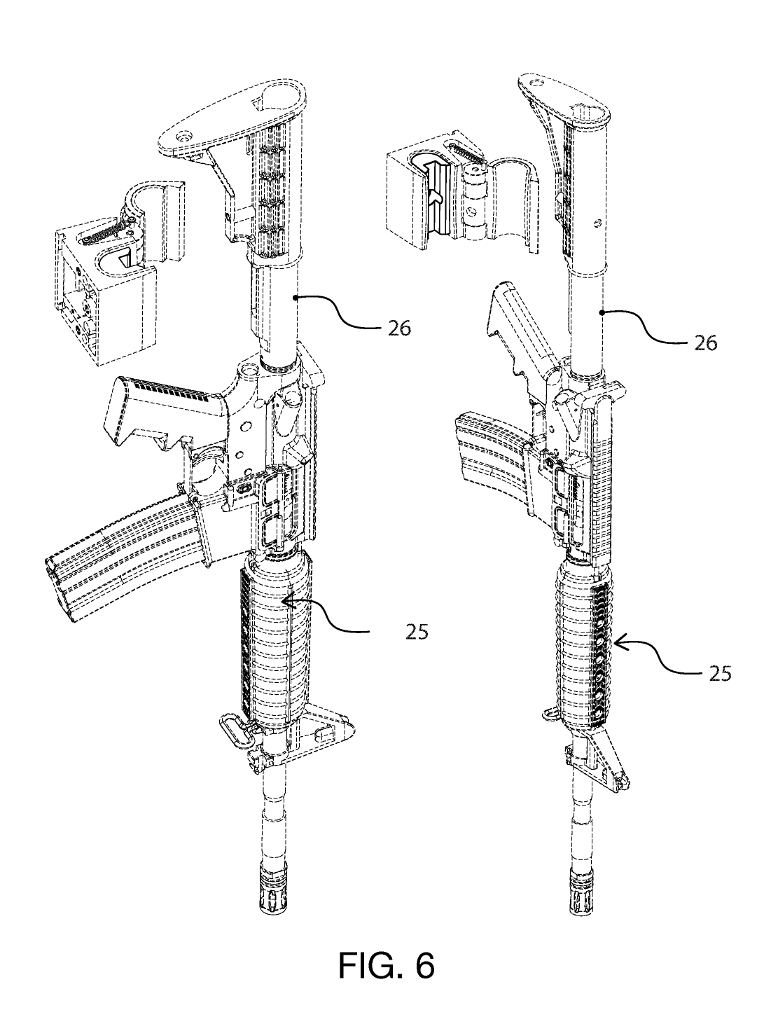

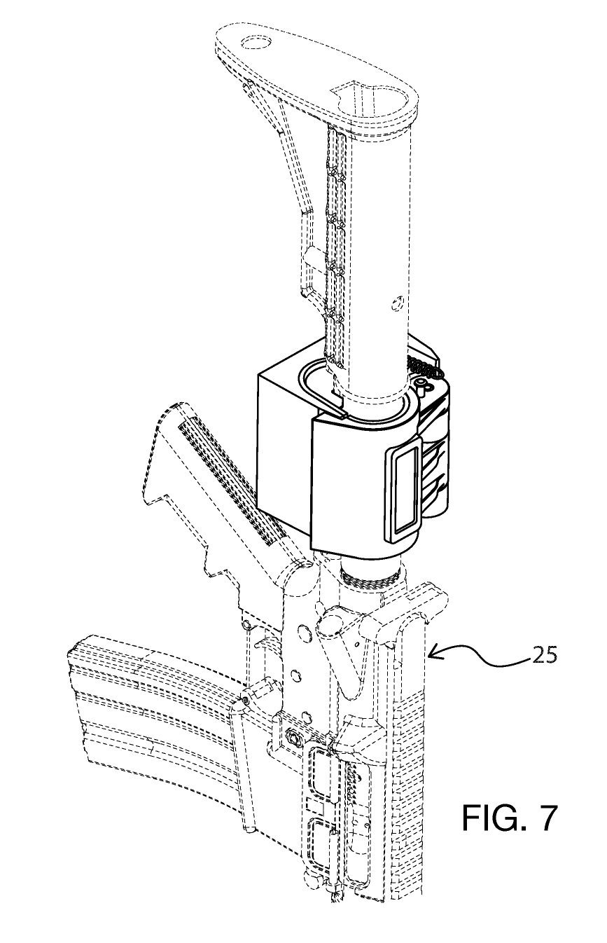

As shown in FIGS. 6 and 7, the gunlock can be firmly anchored to a vehicle by lock 10 around buffer tube 26 on typical police rifle 25.

Although the present invention has been described with reference to certain preferred embodiments thereof, other versions are readily apparent to those of ordinary skill in the preferred embodiments contained herein.

What is claimed is:

1. An insert for a clamshell type of gunlock, said gunlock having a base and an arm that is used to secure a shotgun, wherein said insert modifies said gunlock to lock a rifle, said insert comprising:
a molded insert having external dimensions to fit within the opening of said clamshell gunlock provided by the arm of said clamshell gunlock and said base of said gunlock when said arm is locked within said base.

2. The insert of claim 1 wherein said insert further comprises at least one screw that rigidly affixes said insert into a threaded hole in said base of said clamshell gunlock.

3. The insert of claim 1 wherein said insert is molded out of rubber.

4. The insert of claim 1 wherein said insert further comprises a plurality of finger slots molded into said insert to reduce the amount of material needed to mold said insert and also to provide access to said threaded hole in the base of said clamshell gunlock.

5. The insert of claim 1 wherein said insert has a chamfer molded into said insert to help guide the part of the rifle that is being locked.

6. The insert of claim 1 further comprising a channel molded into said insert that corresponds to the dimension of a buffer tube of an AR-15 rifle wherein said rifle is held securely locked without the rifle rattling or being cosmetically being damaged while being locked in said modified clamshell gunlock.
